(19) United States
(12) Patent Application Publication
(10) Pub. No.: US 2006/0209151 A1
(43) Pub. Date: Sep. 21, 2006

(54) Image forming apparatus

(76) Inventors: Takahiro Tamiya, Tokyo (JP); Katsuhiro Echigo, Tokyo (JP); Hajime Oyama, Tokyo (JP); Hisashi Kikuchi, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/367,541

(22) Filed: Mar. 6, 2006

(30) Foreign Application Priority Data
Mar. 18, 2005 (JP) 2005-078985
Mar. 22, 2005 (JP) 2005-080813
Dec. 15, 2005 (JP) 2005-361965

(51) Int. Cl. B41J 2/01

(52) U.S. Cl. 347/103

(57) ABSTRACT

A transfer member and a downstream-side neutralizing electrode make a contact with a rear portion of an intermediate transfer belt within a contact region. A transfer voltage with an opposite polarity to a regularly charged polarity of a toner is applied to the transfer member. A voltage with a same polarity as the regularly charged polarity of the toner is applied to the downstream-side neutralizing electrode.

### CROSS-REFERENCE TO RELATED APPLICATIONS

The present document incorporates by reference the entire contents of Japanese priority document, 2005-078985 filed in Japan on Mar. 18, 2005, 2005-080813 filed in Japan on Mar. 22, 2005 and 2005-361965 filed in Japan on Dec. 15, 2005.

### BACKGROUND OF THE INVENTION

1. Field of the Invention

The present invention relates to an image forming apparatus that performs a primary transfer of a toner image formed on an image carrier to an intermediate transfer belt that is driven while contacting with the image carrier, and a secondary transfer of a toner image formed on the intermediate transfer belt to a recording medium.

2. Description of the Related Art

An image forming apparatus that primarily transfers a toner image formed on an image carrier to an intermediate transfer belt that is driven while contacting with the image carrier, and secondarily transfers a toner image formed on the intermediate transfer belt to a recording medium is well known, such as a copying machine, a printer, a facsimile machine, and a multifunction product (see, for example, Japanese Patent No. 3346063). In such an image forming apparatus, a small amount of toner adheres around the toner image transferred on the intermediate transfer belt in a scattered manner, which is called a transfer dust. FIG. 15 is a schematic diagram for illustrating a source of the transfer dust and conventional measures against the transfer dust.

In FIG. 15, an image carrier 3A configured by a drum-like photoconductor is rotationally driven in a direction of arrow, and a toner image including toner particles T is formed on the image carrier 3A during the rotational driving. Toner particles T are charged to a regular polarity, namely, a minus polarity in FIG. 15. An intermediate transfer belt 4A, which is driven in a direction of arrow A, is disposed to face the image carrier 3A. A pair of guide rollers 21A, 22A is pressed on a surface of the image carrier 3A via the intermediate transfer belt 4A, so that the intermediate transfer belt 4A contacts with the surface of the image carrier 3A.

When a range between the most upstream-side position XA of a portion of the intermediate transfer belt contacting with the image carrier 3A and the most downstream-side position YA thereof is called “contact region NA”, a transfer member 13A abuts on a rear portion of the intermediate transfer belt 4A positioned within the contact region NA. The transfer member 13A is formed of a blade. A transfer voltage with an opposite polarity to a regularly charged polarity (a plus polarity in this example) of toner particles T is applied to the transfer member 13A by a power source 23A. Thereby, an electric field is formed between the image carrier 3A and the intermediate transfer belt 4A so that a toner image on the image carrier 3A electrostatically moves to a surface of the intermediate transfer belt 4A and the toner image is primarily transferred to the intermediate transfer belt 4A. Reference letter T1 is attached to toner particles constituting a toner image transferred on the intermediate transfer belt 4A. The toner image primarily transferred on the intermediate transfer belt 4A in this manner is secondarily transferred on a recording medium that is not shown in FIG. 15 and the toner image is fixed, so that a final image can be obtained.

A wedge-shaped inlet side space SIA is defined between a portion of the intermediate transfer belt positioned on an upstream-side from the contact region NA where the intermediate transfer belt 4A contacts with a surface of the image carrier 3A and the image carrier 3A, and a wedge-shaped outlet side space SOA is similarly formed between a portion of the intermediate transfer belt positioned on a downstream-side from the contact region NA and the image carrier 3A.

As described above, since the transfer member 13A applied with the transfer voltage with a plus polarity contacts with a rear surface of the intermediate transfer belt 4A, charges with the plus polarity are given to the rear surface of the intermediate transfer belt 4A, and the charges move to regions of the inlet side space SIA and the outlet side space SOA along the rear surface of the intermediate transfer belt 4A. Furthermore, charges are retained within the intermediate transfer belt 4A and the charges retained reach the region of the outlet side space SOA according to movement of the intermediate transfer belt 4A. In the inlet side space SIA and the outlet side space SOA, therefore, discharge occurs between the intermediate transfer belt 4A and the image carrier 3A, so that the polarity of toner particles T of a portion of the toner image on the image carrier 3A and the polarity of toner particles T1 of a portion of the toner image transferred on the intermediate transfer belt 4A are reversed to a plus polarity due to the discharge. Toner particles whose polarity is reversed in this manner are electrostatically scattered on a surface near the toner image to cause transfer dust to be generated.

To prevent the generation of transfer dust, a constitution that the intermediate transfer belt 4A is neutralized by applying voltage having the same polarity (the minus polarity in FIG. 15) as the regularly charged polarity of toner particles to the respective rollers 21A, 22A shown in FIG. 15 has been proposed. The constitution prevents discharge from occurring in the inlet side space SIA and the outlet side space SOA by neutralizing the intermediate transfer belt 4A, thereby preventing reverse of the toner particle polarity. However, there is a possibility that the intermediate transfer belt 4A cannot be neutralized sufficiently utilizing only this constitution, especially, charges remain on the intermediate transfer belt 4A that has reached the outlet side space SOA, so that the remaining charges keep discharging in the outlet side space SOA, which can cause transfer dust on the intermediate transfer belt.

### SUMMARY OF THE INVENTION

It is an object of the present invention to at least solve the problems in the conventional technology.

An image forming apparatus according to one aspect of the present invention performs a primary transfer of a toner image formed on an image carrier to an intermediate transfer belt that is driven while contacting with the image carrier, and a secondary transfer of the toner image on the intermediate transfer belt to a recording medium to obtain a recorded image. The image forming apparatus includes a transfer member that makes, when a range of a portion of the intermediate transfer belt contacting with the image carrier, which is positioned between the most upstream-side position and the most downstream-side position in a moving direction of the intermediate transfer belt, is defined as a contact region, a contact with a rear portion of the intermediate transfer belt within the contact region, as a primary transfer device that performs the primary transfer of the toner image on the image carrier to the intermediate transfer belt; and a downstream-side neutralizing electrode that makes a contact with the rear portion of the intermediate transfer belt, which is positioned at a downstream-side in the moving direction of the intermediate transfer belt from a position where the transfer member makes a contact with the intermediate transfer belt and at an upstream-side in the moving direction of the intermediate transfer belt from the most downstream-side position. A transfer voltage with an opposite polarity to a regularly charged polarity of a toner is applied to the transfer member. A voltage with a same polarity as the regularly charged polarity of the toner is applied to the downstream-side neutralizing electrode.

An image forming apparatus according to another aspect of the present invention performs a primary transfer of a toner image formed on an image carrier to an intermediate transfer belt that is driven while contacting with the image carrier, and a secondary transfer of the toner image on the intermediate transfer belt to a recording medium to obtain a recorded image. The image forming apparatus includes a transfer member that makes, when a range of a portion of the intermediate transfer belt contacting with the image carrier, which is positioned between the most upstream-side position and the most downstream-side position in a moving direction of the intermediate transfer belt, is defined as a contact region, a contact with a rear portion of the intermediate transfer belt within the contact region, as a primary transfer device that performs the primary transfer of the toner image on the image carrier to the intermediate transfer belt; and an upstream-side neutralizing electrode that makes a contact with the rear portion of the intermediate transfer belt, which is positioned at an upstream-side in the moving direction of the intermediate transfer belt from a position where the transfer member makes a contact with the intermediate transfer belt and at a downstream-side in the moving direction of the intermediate transfer belt from the most upstream-side position. A transfer voltage with an opposite polarity to a regularly charged polarity of a toner is applied to the transfer member. A voltage with a same polarity as the regularly charged polarity of the toner is applied to the upstream-side neutralizing electrode.

An image forming apparatus according to still another aspect of the present invention performs a primary transfer of a toner image formed on an image carrier to an intermediate transfer belt that is driven while contacting with the image carrier, and a secondary transfer of the toner image on the intermediate transfer belt to a recording medium to obtain a recorded image. The image forming apparatus includes a transfer member that makes, when a range of a portion of the intermediate transfer belt contacting with the image carrier, which is positioned between the most upstream-side position and the most downstream-side position in a moving direction of the intermediate transfer belt, is defined as a contact region, a contact with a rear portion of the intermediate transfer belt within the contact region, as a primary transfer device that performs the primary transfer of the toner image on the image carrier to the intermediate transfer belt; a downstream-side neutralizing electrode that makes a contact with the rear portion of the intermediate transfer belt, which is positioned at a downstream-side in the moving direction of the intermediate transfer belt from a position where the transfer member makes a contact with the intermediate transfer belt and at an upstream-side in the moving direction of the intermediate transfer belt from the most downstream-side position; and an upstream-side neutralizing electrode that makes a contact with the rear portion of the intermediate transfer belt, which is positioned at an upstream-side in the moving direction of the intermediate transfer belt from a position where the transfer member makes a contact with the intermediate transfer belt and at a downstream-side in the moving direction of the intermediate transfer belt from the most upstream-side position. A transfer voltage with an opposite polarity to a regularly charged polarity of a toner is applied to the transfer member. A voltage with a same polarity as the regularly charged polarity of the toner is applied to the downstream-side neutralizing electrode and the upstream-side neutralizing electrode.

The above and other-objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an example of an image forming apparatus;

FIG. 2 is a schematic diagram for illustrating a constitution for transferring a toner image formed on an image carrier shown in FIG. 1 to an intermediate transfer belt;

FIG. 3 is a schematic diagram for illustrating a relationship between a transfer blade, a downstream-side neutralizing blade and an upstream-side neutralizing blade, conductive adhesive covering proximal portions of the blades, and a terminal for a power source;

FIGS. 4A to 4D are schematic diagrams for illustrating an example in which the transfer blade, the downstream-side neutralizing blade, and the upstream-side neutralizing blade are directly fitted into grooves formed in a supporting member;

FIGS. 5 and 6 are schematic diagrams for illustrating an example in which the transfer blade, the downstream-side neutralizing blade, and the upstream-side neutralizing blade are made of metal;

FIG. 7 is a schematic diagram of another image forming apparatus, which is similar to FIG. 2;

FIG. 8 is schematic diagram of an image forming apparatus with all of a transfer member, a downstream-side neutralizing electrode, and an upstream-side neutralizing electrode formed of rollers;

FIG. 9 is a perspective view of a transfer roller, a downstream-side neutralizing roller, and an upstream-side neutralizing roller and plain bearings for supporting the rollers;

FIG. 10 is a schematic diagram of an image forming apparatus with a leak current detector;

FIG. 11 is a timing chart of an operation when a leak current is detected by the leak current detector;

FIG. 12 is a schematic diagram for illustrating an electric field dependency of a volume resistance of an intermediate transfer belt;

FIG. 13 is a graph of the electric field dependency of the volume resistance of the intermediate transfer belt;

FIG. 14 is a graph of an electric field dependency of a surface resistance of the intermediate transfer belt; and

FIG. 15 is a schematic diagram for illustrating a source of transfer dust and conventional measures against the transfer dust.

### DETAILED DESCRIPTION OF THE PREFERRED EMBODIMENTS

Exemplary embodiments of the present invention are explained below in detail with reference to the accompanying drawings.

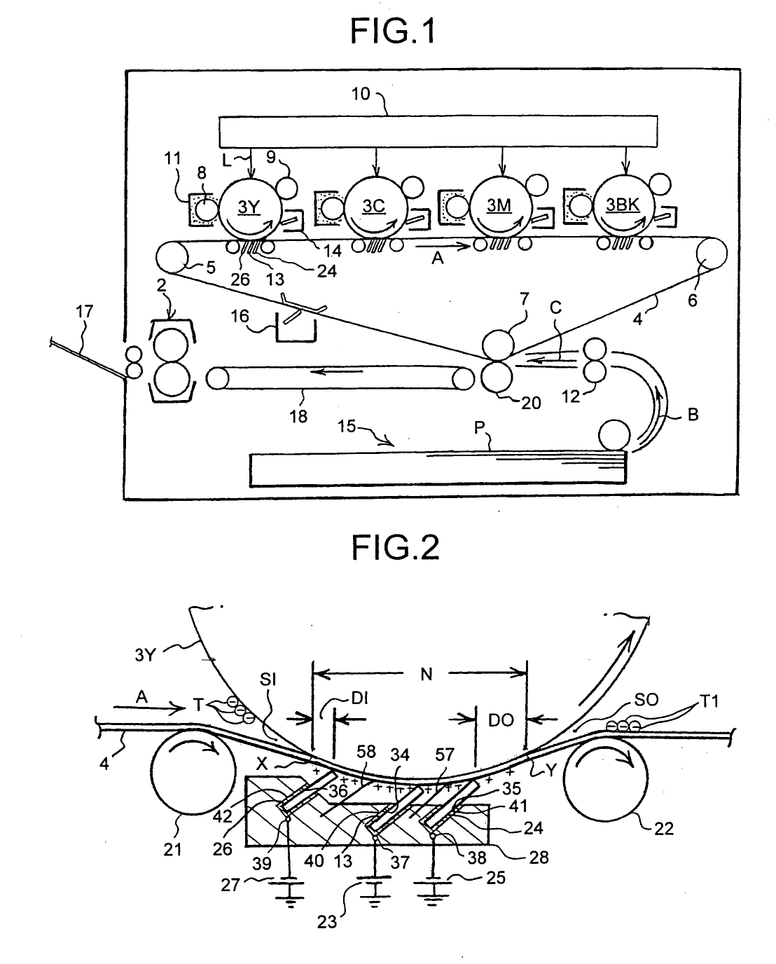

FIG. 1 is a schematic diagram of an example of an image forming apparatus. The image forming apparatus has four image carriers 3Y, 3C, 3M, 3BK, each being formed of a drum-like photoconductor, and an yellow toner image, a cyan toner image, a magenta toner image, and a black toner image are respectively formed on circumferential surfaces of the respective image carriers. An intermediate transfer belt 4 is provided to face the image carriers 3Y to 3BK. The intermediate transfer belt 4 formed of an endless belt is spanned around supporting rollers 5, 6, 7, and it is driven in a direction of arrow A for running, while contacting with surfaces of the image carriers 3Y to 3BK, so that toner images on the respective image carriers 3Y to 3BK are primarily transferred on the intermediate transfer belt 4 in superimposition.

Since all of constitutions for forming toner images on the respective image carriers 3Y to 3BK and constitutions for transferring the toner images on the intermediate transfer belt 4 are the same, only a constitution for forming a toner image to the image carrier 3Y to transfer the same to the intermediate transfer belt 4 is explained. The image carrier 3Y is rotationally driven in a counterclockwise direction in FIG. 1, and it is charged to a predetermined polarity by a charging roller 9. It is assumed that the charged polarity is a minus polarity. Light-modulated writing light L (laser light in FIG. 1) emitted from an exposing device 10 is then irradiated on a charging face of the image carrier 3Y, an electrostatic latent image is formed on the image carrier thereby, and the electrostatic latent image is visualized as a yellow toner image by a developing device 11 of a reversing developing system. The developing device 11 shown in FIG. 1 has a developing roller 8 applied with a developing bias, and the electrostatic latent image is visualized as a toner image with dry type developer carried and conveyed by the developing roller 8. As the dry type developer, two component type developer having toner particles and carrier particles or one component type developer that does not have carrier particles is used. In each case, toner particles are charged to a regularly charged polarity (a minus polarity in FIG. 1), such toner particles are electrostatically transferred to an electrostatic latent image formed on the image carrier 3Y, so that the electrostatic latent image is visualized.

On the other hand, a transfer member 13 formed of a blade is disposed to be approximately opposed to the image carrier 3Y via the intermediate transfer belt 4, and a transfer voltage with an opposite polarity (the plus polarity in FIG. 1) to the regularly charged polarity of toner on the image carrier 3Y is applied to the transfer member 13, so that an electric field is formed between the image carrier 3Y and the intermediate transfer belt 4 and the toner image on the image carrier 3Y is transferred to the intermediate transfer belt 4 driven in the direction of arrow A for running. Thus, the transfer member 13 constitutes a transfer device for performing primary transfer of a toner image on the image carrier to intermediate transfer belt. The transfer member 13 abuts on a rear surface of the intermediate transfer belt 4 opposed from a face thereof transferred with a toner image. Post-transfer residual toner adhered on the image carrier 3Y after transfer of the toner image is removed by a cleaning device 14, and the image carrier after transfer of the toner image is irradiated with neutralizing light from a neutralizing lamp (not shown), so that a surface potential of the image carrier is initialized, and it is ready for the next imaging process.

A cyan toner image, a magenta toner image, and a black toner image are respectively formed on the remaining image carriers 3C, 3M, 3BK shown in FIG. 1 in the same manner to the above, and these toner images are sequentially transferred on the intermediate transfer belt 4 on which the yellow toner image is transferred in a superimposing manner. Thus, a four color superimposed toner image is formed on the intermediate transfer belt 4.

A transfer roller 20 for secondary transfer of a toner image is provided at a position opposed to the supporting roller 7 via the intermediate transfer belt 4, and a paper feed unit 15 is disposed below the transfer roller 20. A recording medium P serving as a final transfer member, which is formed of transfer paper or a resin film fed from the paper feed unit 15 in a direction of arrow B is fed in between the intermediate transfer belt 4 and the transfer roller 20 at a predetermined timing according to rotation of a registration roller pair 12 as indicated by arrow C. Thus, when the recording medium P passes through the transfer roller 20, a transfer voltage with an opposite polarity (the plus polarity in FIG. 1) to the regularly charged polarity of toner for a toner image on the intermediate transfer belt 4 is applied to the transfer roller 20, so that an electric field is formed between the intermediate transfer belt 4 and the recording medium P and the toner image on the intermediate transfer belt 4 is electrostatically secondary transferred on the recording medium P. Post-transfer residual toner adhering on the intermediate transfer belt 4 after transfer of the toner image is removed by a cleaning device 16.

The recording medium P with the transferred toner image is conveyed by a conveying device 18 to pass through a fixing device 2. At that time, the transferred toner image is fixed on the recording medium P due to heat and pressure. The recording medium P which has passed through the fixing device 2 is discharged to a paper discharge unit 17. A recording medium P with a full color image thus formed can be obtained.

As described above, the image forming apparatus according to an embodiment of the present invention is constituted to perform primary transfer of a toner image formed on the image carrier on the intermediate transfer belt driven for running while contacting with the image carrier and perform secondary transfer of the toner image on the intermediate transfer belt to a recording medium to obtain a recorded image.

A constitution for blocking or effectively suppressing generation of transfer dust adhering around a toner image transferred from the image carrier to the intermediate transfer belt in a state that toner particles are scattered is explained next. Since all constitutions for preventing transfer dust regarding respective toner images transferred from the respective image carriers 3Y to 3BK to the intermediate transfer belt 4 are substantially the same, only the constitution for preventing transfer dust regarding a toner image transferred from the image carrier 3Y to the intermediate transfer belt 4 is explained.

FIG. 2 is a schematic diagram for illustrating the image carrier 3Y, the intermediate transfer belt 4, and the transfer member 13. The intermediate transfer belt 4 driven for running in a direction of arrow A is guided by two guide rollers 21 and 22, so that the intermediate transfer belt 4 contacts with a surface of the image carrier 3Y rotationally driven in a direction of arrow directly or via toner, and the image carrier 3Y and the intermediate transfer belt 4 move in the same direction in the contacting portion. The guide rollers 21 and 22 are in an electrically floating state.

When a range of a portion of the intermediate transfer belt contacting with the image carrier 3Y between the most upstream-side position X and the most downstream-side position Y in a moving direction of the intermediate transfer belt is defined as a contact region N like the conventional example shown in FIG. 15, the transfer member 13 that abuts on a rear portion of the intermediate transfer belt 4 within the contact region N is used as the primary transfer device that performs primary transfer of a toner image on the image carrier 3Y to the intermediate transfer belt 4, and a transfer voltage with an opposite polarity (a plus polarity in FIG. 2) to the regularly charged polarity of toner is applied to the transfer member 13 by a power source 23 in the image forming apparatus of the embodiment, as described above. The application voltage is, for example, about +2 kilovolts. Thereby, as described above, a transfer electric field is formed between the image carrier 3Y and the intermediate transfer belt 3, so that the toner image on the image carrier 3Y is transferred to the intermediate transfer belt 4. Each toner particle on the image carrier 3Y before transferred is denoted by reference letter T, while each toner particle constituting a toner image transferred on the intermediate transfer belt 4 is denoted by reference letter T1.

In the image forming apparatus shown in FIG. 2, a wedge-shaped inlet side space SI is defined, between a portion of the intermediate transfer belt and the image carrier 3Y positioned on an upstream-side of the contact region N and a wedge-shaped outlet side space SO is defined between a portion of the intermediate transfer belt and the image carrier 3Y positioned on a downstream-side of the contact region N.

A downstream-side neutralizing electrode 24 shown in FIGS. 1 and 2 is provided in the image forming apparatus of the embodiment. The downstream-side neutralizing electrode 24 is formed of a blade, and it abuts on a portion of the rear surface of the intermediate transfer belt 4 positioned on a downstream-side, in the moving direction of the intermediate transfer belt, of a position where the transfer member 13 abuts on the intermediate transfer belt 4 and on an upstream-side, in the moving direction of the intermediate transfer belt, of the most downstream-side position Y. Besides, the downstream-side neutralizing electrode 24 is applied with a voltage with the same polarity (a minus polarity in FIG. 2) as the regularly charged polarity of toner by a power source 25. The application voltage is, for example, about −0.1 to −1 kilovolt, preferably, −200 to −600 Volts. The most downstream-side position Y of the contact region N where the intermediate transfer belt 4 contacts with a surface of the image carrier 3Y directly or via toner particles and a position where the downstream-side neutralizing electrode 24 abuts on a rear surface of the intermediate transfer belt 4 are spaced from each other by a certain distance DO.

Since the transfer member 13 applied with the transfer voltage of a plus polarity abuts on the rear surface of the intermediate transfer belt 4, charges with the plus polarity are applied on the rear surface of the transfer member 13, the charges are moved toward the outlet side space SO along the rear surface of the intermediate transfer belt 4, and charges retained on the intermediate transfer belt 4 are moved toward the outlet side space SO according to movement of the intermediate transfer belt 4. However, since the downstream-side neutralizing electrode 24 applied with a voltage of a minus polarity abuts on a portion of the intermediate transfer belt 4 positioned on the upstream-side, in the moving direction of the intermediate transfer belt, of the most downstream-side position Y of the contact region N, the charges moved as described above are neutralized so that the intermediate transfer belt 4 is neutralized. However, the intermediate transfer belt is not neutralized completely when the portion of the intermediate transfer belt has passed through the downstream-side neutralizing electrode 24, and charges with the plus polarity remain on the intermediate transfer belt 4 that has passed through the downstream-side neutralizing electrode 24 to some extent. In the conventional image forming apparatus shown in FIG. 15, discharging occurs in the outlet side space SOA due to the residual charges.

On the other hand, in the image forming apparatus shown in FIG. 2, since the downstream-side neutralizing electrode 24 is positioned at a portion of the intermediate transfer belt positioned on an upstream-side of the most downstream-side position Y of the contact region N, a portion of the intermediate transfer belt 4 that has passed through the downstream-side neutralizing electrode 24 does not separate from the image carrier 3Y immediately, and it is still with a surface of the image carrier 3Y for a short while. While a portion of the intermediate transfer belt 4 that has passed through the downstream-side neutralizing electrode 24 is contacting with the image carrier 3Y in this manner, the residual charges with the plus polarity are removed due to an operation of the downstream-side neutralizing electrode 24. Accordingly, when the intermediate transfer belt 4 separates from the surface of the image carrier 3Y, charges are not present substantially on the portion of the intermediate transfer belt so that discharging is prevented from occurring in the outlet side space SO. Thereby, transfer dust can be prevented from being generated around a toner image on the intermediate transfer belt in the outlet side space SO. When the intermediate transfer belt 4 separates from the surface of the image carrier 3Y, neutralization of the intermediate transfer belt 4 is completed, so that discharging is not generated in the outlet side space SO.

In the image forming apparatus according to the present embodiment, an upstream-side neutralizing electrode 26 abuts on a portion of the rear surface of the intermediate transfer belt 4 positioned on an upstream-side, in the moving direction of the intermediate transfer belt, of a position where the transfer member 13 contacts with the intermediate transfer belt 4 and on a downstream-side, in the moving direction of the intermediate transfer belt, of the most upstream-side position X. The upstream-side neutralizing electrode 26 is formed of a blade, and it is applied with a voltage with the same polarity (the minus polarity in FIG. 2) as the regularly charged polarity of toner by a power source 27. The most upstream-side position X of the contact region N where the intermediate transfer belt 4 contacts with the image carrier 3Y and a position where the upstream-side neutralizing electrode 26 abuts on the rear surface of the intermediate transfer belt 4 are spaced from each other by a certain distance DI. Therefore, charges with a plus polarity that are applied on the rear surface of the intermediate transfer belt 4 from the transfer member 13 and move toward the inlet side space SI along the rear surface are neutralized due to an operation of the upstream-side neutralizing electrode 26 applied with the voltage with a minus polarity. At that time, even if all charges are not removed, the certain distance DI is present between the upstream-side neutralizing electrode 26 and the most upstream-side position X of the contact region N, so that remaining charges with a plus polarity are removed. Accordingly, discharging does not occur in the inlet side space SI and transfer dust is not generated around a toner image on the image carrier 3Y. The voltage applied to the upstream-side neutralizing electrode 26 is, for example, about −1 kilovolt.

As shown in FIG. 2, the transfer member 13, the downstream-side neutralizing electrode 24, and the upstream-side neutralizing electrode 26 are held by a supporting member 28 made of an insulating material, and the supporting member 28 is pressed toward the intermediate transfer belt 4 by a pressing spring (not shown), so that distal edge portions of the transfer member 13, the downstream-side neutralizing electrode 24, and the upstream-side neutralizing electrode 26 are pressed on the rear surface of the intermediate transfer belt 4.

As described above, in the image forming apparatus according to the present embodiment, both neutralizing electrodes of the downstream-side neutralizing electrode 24 and the upstream-side neutralizing electrode 26 are provided, however, even when only one of both the neutralizing electrodes is provided, the generation of transfer dust can be suppressed.

In the image forming apparatus shown in FIGS. 1 and 2, all of the transfer member 13, the downstream-side neutralizing electrode 24, and the upstream-side neutralizing electrode 26 are formed of blades. As described later, these members can be also formed of rollers. Alternatively, some of the transfer member 13, the downstream-side neutralizing electrode 24, and the upstream-side neutralizing electrode 26 can be formed of blades, while the remaining being formed of rollers. In summary, in the image forming apparatus having the transfer member 13 and the downstream-side neutralizing electrode 24, at least one of the transfer member 13 and the downstream-side neutralizing electrode 24 is formed of a blade, in the image forming apparatus having the transfer member 13 and the upstream-side neutralizing electrode 26, at least one of the transfer member 13 and the upstream-side neutralizing electrode 26 is formed of a blade, and in the image forming apparatus having the transfer member 13, the downstream-side neutralizing electrode 24, and the upstream-side neutralizing electrode 26, at least one of the transfer member 13, the downstream-side neutralizing electrode 24, and the upstream-side neutralizing electrode 26 is formed of a blade, as shown in FIGS. 1 and 2.

In explanation about the image forming apparatus where the transfer member 13, the downstream-side neutralizing electrode 24, and the upstream-side neutralizing electrode 26 are formed of blades, the transfer member 13 is called “transfer member 13”, the downstream-side neutralizing electrode 24 is called “downstream-side neutralizing blade 24”, and the upstream-side neutralizing electrode 26 is called “upstream-side neutralizing blade 26” according to need.

A width of the contact region N shown in FIG. 2 in the moving direction of the intermediate transfer belt is small. However, when the transfer member 13, the downstream-side neutralizing electrode 24, and the upstream-side neutralizing electrode 26 are formed of blades like the image forming apparatus according to the embodiment, they can be disposed within the small contact region N without any difficulty by making the transfer member 13, the downstream-side neutralizing electrode 24, and the upstream-side neutralizing electrode 26 of blades. Specifically, it is possible to set a distance between the downstream-side neutralizing electrode 24 and the upstream-side neutralizing electrode 26 to a small distance of, for example, about 4 millimeters, so that the transfer member 13, the downstream-side neutralizing electrode 24, and the upstream-side neutralizing electrode 26 can disposed in a considerably close manner.

When a clearance between the transfer member 13 and the downstream-side neutralizing electrode 24 and a clearance between the transfer member 13 and the upstream-side neutralizing electrode 26 are small, discharging can occur between blades adjacent to each other. Occurrence of such discharging causes lowering of transfer efficiency of a toner image to the intermediate transfer belt 4 from the image carrier 3Y. As shown in FIG. 2, therefore, insulating sheets 57 and 58 are disposed in between respective blades adjacent to each other and proximal ends of the respective insulating sheets 57 and 58 are fixed to the supporting member 28, so that occurrence of discharging between adjacent blades can be prevented. While it is preferable that distal ends of the respective insulating sheets 57 and 58 being in contact with the rear surface of the intermediate transfer belt 4, a slight clearance can be allowed between each insulating sheet and the intermediate transfer belt. When the insulating sheets 57 and 58 are caused to abut on the intermediate transfer belt 4, it is preferable that each insulating sheet is made of a member with small bending rigidity so that a drawback of the intermediate transfer belt 4 being damaged is prevented. As the material for the insulating sheets 57 and 58, for example, polyethylene terephthalate (PET) can be used.

It is preferable that the transfer member 13, the downstream-side neutralizing electrode 24, and the upstream-side neutralizing electrode 26 are made of an elastic material with a volume resistance of 10⁶ Ω·cm to 10¹² Ω·cm. By using the blades with a relatively high volume resistance in this manner and applying voltages to these blades respectively, charges can be applied to the intermediate transfer belt due to discharging occurring between the respective blades and the intermediate transfer belt 4.

As the transfer member 13, the downstream-side neutralizing electrode 24, and the upstream-side neutralizing electrode 26, conductive blades can be used. In that case, charges are injected into the intermediate transfer belt 4 from each blade applied with a voltage. When charges are applied to the intermediate transfer belt 4 in this manner, each blade makes a contact with the rear surface of the intermediate transfer belt having fine undulation, so that it is made difficult to apply charges to the intermediate transfer belt 4 stably.

On the other hand, it is constituted to apply charges to the intermediate transfer belt utilizing discharging occurring between each blade and the intermediate transfer belt 4, even if there is fine undulation on the rear surface of the intermediate transfer belt 4, it become easy to charge the rear surface more evenly. When each blade has a high volume resistance, as described above, even if discharging occurs between blades close to each other, drawbacks such as the power sources and the blades being damaged due to flowing of large current through each blade do not occur.

As a specific material for the transfer member 13, the downstream-side neutralizing electrode 24, and the upstream-side neutralizing electrode 26, a material obtained by mixing carbon into a polymer material such as polyurethane resin, silicone resin, or fluorine resin or a material obtained by mixing carbon into a rubber material such as CR, EPDM, or hydrin rubber can be used. By molding such a material, a blade having a thickness of, for example, about 0.5 millimeter to 1.5 millimeters can be formed.

In the image forming apparatus shown in FIG. 2, the transfer member 13, the downstream-side neutralizing electrode 24, and the upstream-side neutralizing electrode 26 are fitted at their proximal ends into grooves 34, 35, 36 formed in the supporting member 28 to be supported to the supporting member 28. It is advantageous that the supporting member 28 is made of an elastic material such as rubber. By making the supporting member 28 that supports the transfer member 13, the downstream-side neutralizing electrode 24, and the upstream-side neutralizing electrode 26 from an elastic material such as rubber in this manner, pressure applied to toner present between the image carrier 3Y and the intermediate transfer belt 4 can be suppressed to be low, so that a risk of aggregation of toner can be eliminated.

When the supporting member 28 is made of a rigid material, the transfer member 13, the downstream-side neutralizing electrode 24, and the upstream-side neutralizing electrode 26 are firmly held by the supporting member 28, and the transfer member 13, the downstream-side neutralizing electrode 24, and the upstream-side neutralizing electrode 26 are brought in pressure contact with the intermediate transfer belt 4 with large pressure, large pressure is applied to toner particles between the image carrier 3Y and the intermediate transfer belt 4 so that the toner particles are aggregated. As a result, the toner particles are not transferred on the intermediate transfer belt 4, so that portions where toner particles lack, which are referred to as “spots” or “unprinted parts”, are formed on a final image, which can result in deterioration of image quality. On the other hand, by making the supporting member 28 from an elastic material, such a drawback can be avoided.

As shown in FIG. 4A, the respective proximal ends of the transfer member 13, the downstream-side neutralizing electrode 24, and the upstream-side neutralizing electrode 26 can be directly fitted into the respective grooves 34, 35, 36 formed in the supporting member 28, so that respective terminals 37, 38, 39 of the power sources 23, 25, 27 are brought in contact with the proximal ends of the transfer member 13, the downstream-side neutralizing electrode 24, and the upstream-side neutralizing electrode 26. In this case, as shown in FIG. 4B, constitution must be adopted to bring the transfer member 13, the downstream-side neutralizing electrode 24, and the upstream-side neutralizing electrode 26 in contact with the respective terminals 37, 38, 39 over their entire lengths in their longitudinal directions, thereby allowing even application of a voltage to the intermediate transfer belt 4 over its entire width.

However, since the transfer member 13, the downstream-side neutralizing electrode 24, and the upstream-side neutralizing electrode 26 abut on the rear surface of the intermediate transfer belt 4 driven for running in the direction of arrow A, the transfer member 13, the downstream-side neutralizing electrode 24, and the upstream-side neutralizing electrode 26 receive large forces from the intermediate transfer belt 4, so that these blades can be inclined, as shown in FIG. 4C. As shown in FIG. 4D, there can be a problem that contact failure occurs between the transfer member 13, the downstream-side neutralizing electrode 24, and the upstream-side neutralizing electrode 26, and the respective terminals 37, 38, 39 due to the inclination, so that a voltage is not evenly applied to the intermediate transfer belt 4 over its entire width, which results in occurrence of uneven transfer of a toner image or transfer dust.

In the image forming apparatus shown in FIG. 2, the proximal portions of the transfer member 13, the downstream-side neutralizing electrode 24, and the upstream-side neutralizing electrode 26 are covered with conductive adhesives 40, 41, 42 with adhesion over their entire lengths, and the proximal ends of the transfer member 13, the downstream-side neutralizing electrode 24, and the upstream-side neutralizing electrode 26 that are covered with the conductive adhesives 40, 41, 42 are fitted into the grooves 34, 35, 35 formed in the supporting member 28, so that the proximal ends of the transfer member 13, the downstream-side neutralizing electrode 24, and the upstream-side neutralizing electrode 26 come in close contact with faces defining the grooves 34, 35, 37 via the conductive adhesives 40, 41, 42. The terminals 37, 38, 39 of the power sources 23, 25, 27 applying voltages to the transfer member 13, the downstream-side neutralizing electrode 24, and the upstream-side neutralizing electrode 26 are adhered to the conductive adhesives 40, 41, 42. The respective terminals 37, 38, 39 are engaged with the respective conductive adhesives 40, 41, 42 via simple contact with the respective conductive adhesives 40, 41, 42, integral bonding thereto, or the like.

With the above constitution, since the transfer member 13, the downstream-side neutralizing electrode 24, and the upstream-side neutralizing electrode 26 come in close contact with the respective conductive adhesives 40, 41, 42 over their entire lengths I the longitudinal direction and the respective conductive adhesives 40, 41, 42 also come in elastically close contact with the faces of the respective grooves 34, 35, 36, the transfer member 13, the downstream-side neutralizing electrode 24, and the upstream-side neutralizing electrode 26 are prevented from being largely fluctuated to the respective grooves 34, 35, 36, as shown in FIG. 9C. In addition, since the respective terminals 37, 38, 39 are also engaged with the conductive adhesives 40, 41, 42 having adhesion, the former and the latter come in close contact with each other due to adhesion. Therefore, the transfer member 13, the downstream-side neutralizing electrode 24, and the upstream-side neutralizing electrode 26 can evenly apply their voltages to the intermediate transfer belt 4 over an entire width thereof, so that occurrence of uneven transfer of a toner image or transfer dust can be prevented.

As shown in FIG. 2, the transfer member 13, the downstream-side neutralizing electrode 24, and the upstream-side neutralizing electrode 26 abut on the intermediate transfer belt 4 in a trailing direction of the intermediate transfer belt 4 to a moving direction thereof. Thereby, it is advantageous that turning-up or vibrations of the transfer member 13, the downstream-side neutralizing electrode 24, and the upstream-side neutralizing electrode 26 can be prevented. However, it is also possible to cause the transfer member 13, the downstream-side neutralizing electrode 24, and the upstream-side neutralizing electrode 26 to abut on the intermediate transfer belt 4 in a counter direction thereof.

The transfer member 13, the downstream-side neutralizing electrode 24, and the upstream-side neutralizing electrode 26 are generally made of a medium resistance elastic material having the volume resistance as described above. However, when such an elastic material is used as material for the transfer member 13, the downstream-side neutralizing electrode 24, and the upstream-side neutralizing electrode 26, the respective blades deform along their longitudinal directions in a corrugated state due to low rigidity of the material, so that the transfer member 13, the downstream-side neutralizing electrode 24, and the upstream-side neutralizing electrode 26 may not evenly abut on the intermediate transfer belt 4 over their entire lengths in their longitudinal directions. In this state, occurrence of uneven transfer of a toner image cannot be prevented.

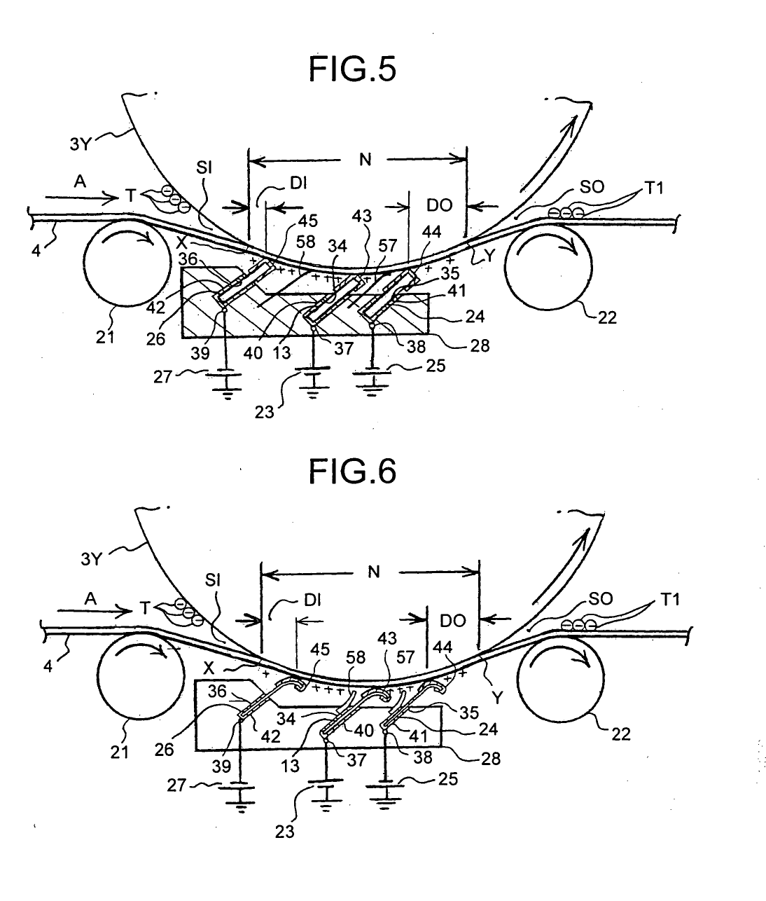

In an image forming apparatus shown in FIG. 5, therefore, the transfer member 13, the downstream-side neutralizing electrode 24, and the upstream-side neutralizing electrode 26 are made of metal with rigidity higher than that of the elastic material. By using the transfer member 13, the downstream-side neutralizing electrode 24, and the upstream-side neutralizing electrode 26 having such high rigidity, the transfer member 13, the downstream-side neutralizing electrode 24, and the upstream-side neutralizing electrode 26 evenly abut on the intermediate transfer belt 4 over their entire lengths in their longitudinal directions, so that occurrence of uneven transfer of a toner image can be prevented.

However, since a blade made of metal is generally conductive, when the transfer member 13, the downstream-side neutralizing electrode 24, and the upstream-side neutralizing electrode 26 made of metal directly contact with the intermediate transfer belt 4, charges are injected from the transfer member 13, the downstream-side neutralizing electrode 24, and the upstream-side neutralizing electrode 26 applied with voltages into the intermediate transfer belt 4, as previously explained, so that it is made difficult to supply charges to the intermediate transfer belt 4 stably.

In the image forming apparatus shown in FIG. 5, therefore, the distal ends of the transfer member 13, the downstream-side neutralizing electrode 24, and the upstream-side neutralizing electrode 26 are covered with medium resistance covering materials 43, 44, 45 having a volume resistance of, for example, 10⁶ to 10¹²Ω·cm, so that the transfer member 13, the downstream-side neutralizing electrode 24, and the upstream-side neutralizing electrode 26 abut on the rear surface of the intermediate transfer belt 4 via the respective medium resistance covering materials 43, 44, 45. With this constitution, since charges can be supplied to the intermediate transfer belt 4 due to discharging occurring between the transfer member 13, the downstream-side neutralizing electrode 24, and the upstream-side neutralizing electrode 26, and the intermediate transfer belt 4, even if there is fine undulation on the rear surface of the intermediate transfer belt 4, charges can be evenly supplied to the rear surface.

Since the medium resistance covering materials 43, 44, 45 are positioned among opposing faces of the transfer member 13, the downstream-side neutralizing electrode 24, and the upstream-side neutralizing electrode 26, discharging can be prevented from occurring between adjacent ones of the transfer member 13, the downstream-side neutralizing electrode 24, and the upstream-side neutralizing electrode 26.

It is preferable that the medium resistance covering materials 43, 44, 45 are made of a material softer than that of the rear surface of the intermediate transfer belt 4. This is because, when the hardness of the medium resistance covering materials 43, 44, 45 is high, scratched lines or worn scars can occur on the intermediate transfer belt 4. Since universal hardness of the intermediate transfer belt 4 is generally in a range of 20 N/mm² to 50 N/mm², it is preferable that the hardness of the medium resistance covering material is set to be lower than that of the intermediate transfer belt 4.

As shown in FIG. 6, the transfer member 13, the downstream-side neutralizing electrode 24, and the upstream-side neutralizing electrode 26 are formed of a thin plate so as to easily deform elastically, and distal ends of the respective blades are curved, so that the curved distal ends of the respective blades can be caused to abut on the intermediate transfer belt 4 via the medium resistance covering materials 43, 44, 45 covering the blades.

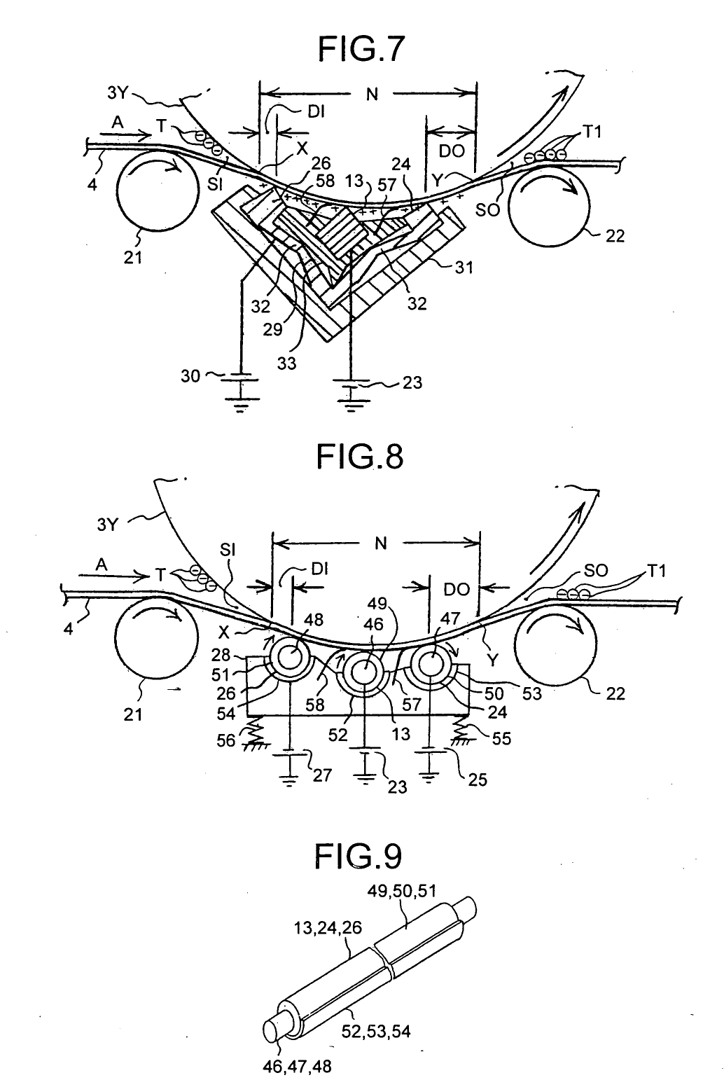

As shown in FIG. 7, the upstream-side neutralizing electrode 26 constituting the upstream-side neutralizing electrode and the downstream-side neutralizing electrode 24 constituting the downstream-side neutralizing electrode are formed integrally so that the blades can be formed as a blade member 29. A voltage with a minus polarity is applied to the blade member 29 by a power source 30. The blade member 29 is held by a holder 31 made of an insulating resin. Portions of the blade member 29 designated with reference numerals 32 are formed in a diaphragm shape, so that the transfer member 13, the downstream-side neutralizing electrode 24, and the upstream-side neutralizing electrode 26 can abut on the rear surface of the intermediate transfer belt 4 with a proper pressure due to deformation of the portions 32.

As described above, by constituting the downstream-side neutralizing electrode 24 and the upstream-side neutralizing electrode 26 as the blade member 29, manufacturing thereof can be not only made easy but also assembly easiness can be improved, and pre-assembly transportation can be favorable. In addition, only one power source 30 can be used to apply voltages to the downstream-side neutralizing electrode 24 and the upstream-side neutralizing electrode 26.

The transfer member 13 is formed in a bar shape with a rectangular cross-sectional configuration, and it is supported by an insulating supporting member 33 held by the blade member 29. When the supporting member 33 is made of an elastic material such as rubber, abnormalities such as spots or unprinted parts are prevented on a final image.

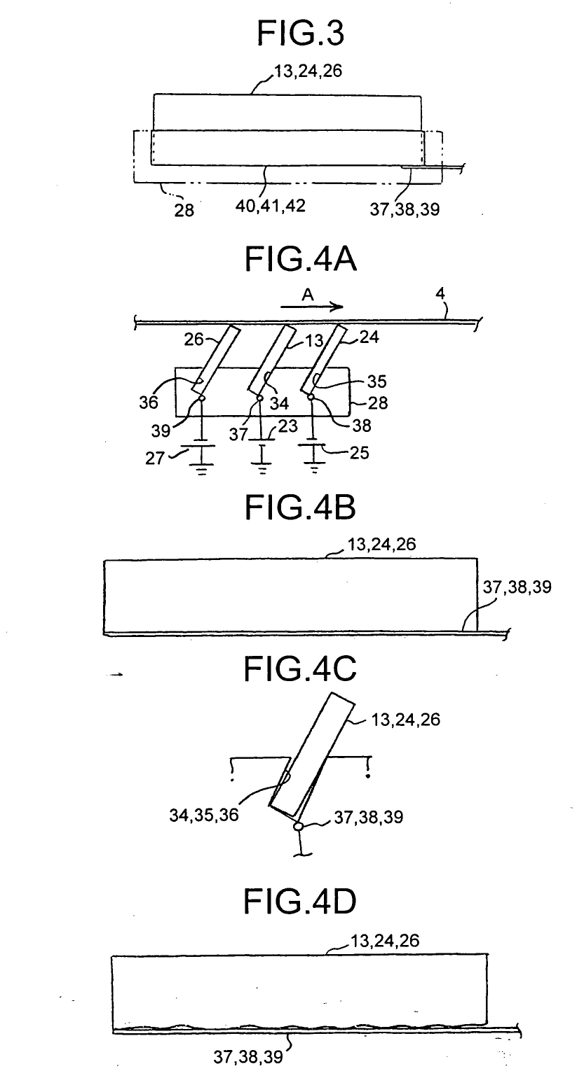

Other constitutions of the image forming apparatus shown in FIGS. 5 to 7 are substantially the same as the constitutions shown in FIGS. 1 to 3, and like parts are designated with like reference numerals shown in FIG. 2.

As described above, rollers can be used as the transfer member 13, the downstream-side neutralizing electrode 24, and the upstream-side neutralizing electrode 26 instead of the blades. That is, in the image forming apparatus having the transfer member and the downstream-side neutralizing electrode, at least one of these members can be formed of a roller, in the image forming apparatus having the transfer member and the upstream-side neutralizing electrode, at least one of these members can be formed of a roller, and in the image forming apparatus having the transfer member, the downstream-side neutralizing electrode, and the upstream-side neutralizing electrode, at least one of these members can be formed of a roller.

FIG. 8 is schematic diagram of an image forming apparatus with all of the transfer member 13, the downstream-side neutralizing electrode 24, and the upstream-side neutralizing electrode 26 formed of rollers.

The transfer member 13, the downstream-side neutralizing electrode 24, and the upstream-side neutralizing electrode 26 are rollers obtained by forming resin such as urethane integrally on outer peripheral faces of metal-made shafts 46, 47, 48 with a diameter of, for example, 7 millimeters and then forming surface layers 49, 50, 51 through cutting work on the resin on the shafts. Outer diameters of the transfer member 13, the downstream-side neutralizing electrode 24, and the upstream-side neutralizing electrode 26 have diameters of, for example, 8 millimeters. A distance between centers of adjacent two of the transfer member 13, the downstream-side neutralizing electrode 24, and the upstream-side neutralizing electrode 26 is set to, for example, about 10 millimeters.

As also shown in FIG. 9, the transfer member 13, the downstream-side neutralizing electrode 24, and the upstream-side neutralizing electrode 26 are rotatably supported to semi-cylindrical plain bearings 52, 53, 54, and the respective plain bearings 52, 53, 54 are fixedly supported to the supporting member 28. The respective terminals of the power sources 23, 25, 27 are engaged with the respective shafts 46, 47, 48 of the transfer member 13, the downstream-side neutralizing electrode 24, and the upstream-side neutralizing electrode 26, so that voltages with a plus polarity and a minus polarity are applied to the transfer member 13, the downstream-side neutralizing electrode 24, and the upstream-side neutralizing electrode 26, respectively.

The surface layers 49, 50, 51 of the transfer member 13, the downstream-side neutralizing electrode 24, and the upstream-side neutralizing electrode 26 are made of a medium resistance material, whose volume resistance is 10⁶ Ω·cm to 10¹² Ω·cm, preferably, 10⁸ Ω·cm to 10¹⁰ Ω·cm. The supporting member 28 is pressed toward the rear surface of the intermediate transfer belt 4 by compression springs 55 and 56, so that the transfer member 13, the downstream-side neutralizing electrode 24, and the upstream-side neutralizing electrode 26 abut on the rear surface of the intermediate transfer belt 4. Even in this case, it is preferable that spring forces of the compression springs 55 and 56 are set to be small and the supporting member 28 is made of an elastic material such that an abnormality image does not occur on a toner image formed on the intermediate transfer belt 4.

An arrangement state of the transfer member 13, the downstream-side neutralizing electrode 24, and the upstream-side neutralizing electrode 26 are the same as that of the transfer member 13, the downstream-side neutralizing electrode 24, and the upstream-side neutralizing electrode 26 in the image forming apparatus shown in FIG. 2. That is, the transfer member 13 abuts on a portion of the rear surface of the intermediate transfer belt 4 which is positioned within the contact region N between the most upstream-side position X of a portion of the intermediate transfer belt 4 contacting with the image carrier 3Y and the most downstream-side position Y thereof in a moving direction of the intermediate transfer belt, so that the transfer member 13 is applied with a transfer voltage with an opposite polarity to the regularly charged polarity of toner by the power source 23. The downstream-side neutralizing electrode 24 abuts on a portion of the rear surface of the intermediate transfer belt 4 that is positioned on a downstream-side from a position where the transfer member 13 abuts on the intermediate transfer belt 4 in the moving direction of the intermediate transfer belt 4 and on the upstream-side from the most downstream-side position Y in the moving direction of the intermediate transfer belt 4. The upstream-side neutralizing electrode 26 abuts on a portion of the rear surface of the intermediate transfer belt 4 that is positioned on an upstream-side from the position where the transfer member 13 abuts on the intermediate transfer belt 4 in the moving direction of the intermediate transfer belt 4 and on the downstream-side from the most upstream-side position X in the moving direction of the intermediate transfer belt 4. Voltages with the same polarity as the regularly charged polarity of toner are applied to the downstream-side neutralizing electrode 24 and the upstream-side neutralizing electrode 26 by the power sources 25 and 27. The transfer member 13, the downstream-side neutralizing electrode 24, and the upstream-side neutralizing electrode 26 are idly rotated according to movement of the intermediate transfer belt 4, or they are rotationally driven in a clockwise direction shown in FIG. 8 by a driving device (not shown).

With the constitution described above, a toner image formed on the image carrier 3Y can be transferred to the intermediate transfer belt 4, and generation of transfer dust can be prevented effectively.

As shown in FIG. 9, the surface layers 49, 50, 51 of the transfer member 13, the downstream-side neutralizing electrode 24, and the upstream-side neutralizing electrode 26 are rotatably supported to the semi-cylindrical plain bearings 52, 53, 54 over their almost entire lengths. Therefore, central portions of the transfer member 13, the downstream-side neutralizing electrode 24, and the upstream-side neutralizing electrode 26 in their longitudinal directions thereof are prevented from being largely flexed such that these rollers project downward, so that the transfer member 13, the downstream-side neutralizing electrode 24, and the upstream-side neutralizing electrode 26 can be caused to abut on the rear surface of the intermediate transfer belt 4 over their entire lengths evenly. Thereby, occurrence of uneven transfer of a toner image can be prevented effectively.

The remaining constitution of the image forming apparatus shown in FIG. 8 is substantially the same as that of the image forming apparatus shown in FIGS. 1 and 2. Similarly, the insulating sheets 57 and 58 are provided among the respective rollers.

By using the transfer member 13, the downstream-side neutralizing electrode 24, and the upstream-side neutralizing electrode 26 like the image forming apparatus shown in FIG. 2, distal edges of the respective blades are worn due to friction between them and the intermediate transfer belt,4 in a time elapsing manner. However, if the wearing is uneven, the transfer member 13, the downstream-side neutralizing electrode 24, and the upstream-side neutralizing electrode 26 cannot abut on the intermediate transfer belt 4 evenly, so that uneven transfer of a toner image or transfer dust can occur.

On the other hand, if the transfer member 13, the downstream-side neutralizing electrode 24, and the upstream-side neutralizing electrode 26 are used, when the intermediate transfer belt 4 moved in the direction of arrow A, the transfer member 13, the downstream-side neutralizing electrode 24, and the upstream-side neutralizing electrode 26 rotates in the clockwise direction in FIG. 8, so that friction can be suppressed to be smaller than the case that the transfer member 13, the downstream-side neutralizing electrode 24, and the upstream-side neutralizing electrode 26 are used, and the transfer member 13, the downstream-side neutralizing electrode 24, and the upstream-side neutralizing electrode 26 can be caused to abut on the intermediate transfer belt 4 evenly. Thereby, occurrence of uneven transfer of a toner image or generation of transfer dust can be prevented effectively, and-a drawback of the intermediate transfer belt 4 being damaged can be prevented.

In the respective embodiment explained above, when paper dust or the like sticky adheres to the rear surface of the intermediate transfer belt 4 in a time elapsing manner, an electric resistance of the rear surface lowers. When the resistance excessively lowers, much current leaks from the transfer member 13 applied with a voltage with a plus polarity to the downstream-side neutralizing electrode 24 and the upstream-side neutralizing electrode 26 via the rear surface of the intermediate transfer belt 4. Thereby, a transfer spotting where toner particles partially lack occurs on a toner image transferred to the intermediate transfer belt 4, which results in deterioration of image quality. When the resistance of the intermediate transfer belt 4 abnormally lowers, it is necessary to notify the information to a user to prompt replacement of the intermediate transfer belt 4 with a new one.

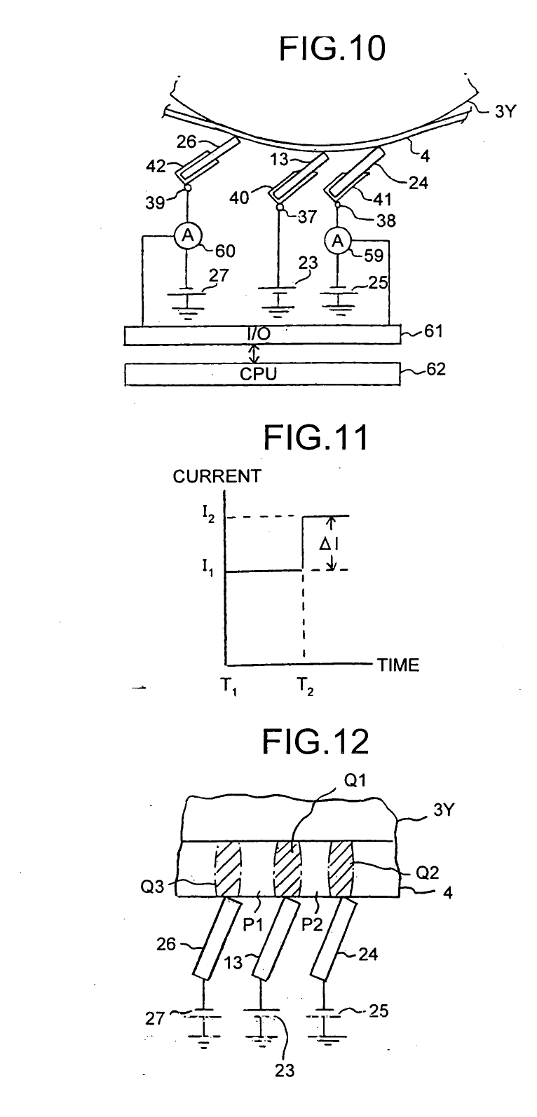

Therefore, it is desirable to provide a leak current detector that detects leak current flowing between the transfer member 13 and the downstream-side neutralizing electrode 24 via the intermediate transfer belt 4 and another leak current detector that detects leak current flowing between the transfer member 13 and the upstream-side neutralizing electrode 26 via the intermediate transfer belt 4. FIG. 10 is one example of this constitution.

In FIG. 10, a first ammeter 59 is interposed between the downstream-side neutralizing electrode 24 and the power source 25, a second ammeter 60 is interposed between the upstream-side neutralizing electrode 26, and the power source 27, and the respective ammeters 59 and 60 are connected to a central processing unit (CPU) 62 via an input/output (I/O) unit 61.

As shown in FIG. 11, a current is first supplied from the power source 25 to the downstream-side neutralizing electrode 24 at a proper time t₀ other than an image forming operation. At this time, a current value detected by the first ammeter 59 is represented as I₁. At that time, currents are not supplied from the power sources 23 and 27 to the transfer member 13 and the upstream-side neutralizing electrode 26. Next, at a time point t₁ shown in FIG. 11, supply of a current from the power source 23 to the transfer member 13 starts. When a current value detected by the first ammeter 59 at that time is represented as I₂, I₂−I₁=ΔI is calculated in the CPU 62, and determination is made about whether ΔI is equal to or more than a threshold Iₜₕ. ΔI>0 means that a current leaks from the transfer member 13 to the downstream-side neutralizing electrode 24 via the intermediate transfer belt 4. Therefore, when the leak current ΔI is equal to or more than the predetermined threshold Iₜₕ, it is determined that the resistance of the intermediate transfer belt 4 lowers excessively, so that abnormality display is made on a display unit (not shown) and operation of the image forming apparatus is stopped. Thereby, a user or a service person replaces the intermediate transfer belt 4 with a new one. Thus, defective transfer of a toner image due to degradation of the intermediate transfer belt 4 can be prevented in advance.

In the same manner, a current is supplied from the power source 27 to the downstream-side neutralizing electrode 26 at the proper time t₀ other than the image forming operation without feeding currents from the power sources 23 and 25 to the transfer member 13 and the downstream-side neutralizing electrode 24. Whether or not a difference (I₂−I₁=ΔI) between a current value I₁ detected by the second ammeter 60 at that time and a current value I₂ detected by the second ammeter 60 when a current is next supplied from the power source 23 to the transfer member 13 is equal to or more than the threshold Iₜₕ is determined. At a time of ΔI≧Iₜₕ, abnormality display is made and operation in the image forming apparatus is stopped.

In the example shown above, the first ammeter 59 and the CPU 62 constitute a leak current detector that detects a leak current flowing between the transfer member 13 and the downstream-side neutralizing electrode 24 via the intermediate transfer belt 4, while the second ammeter 60 and the CPU 62 constitute a leak current detector that detects a leak current flowing between the transfer member 13 and the upstream-side neutralizing electrode 26 via the intermediate transfer belt 4. A constitution that a leak current is detected by detecting a voltage can be adopted.

In an image forming apparatus where the downstream-side neutralizing electrode is provided, whereas the upstream-side neutralizing electrode 26 is not, only the leak current detector that detects a leak current flowing between the transfer member 13 and the downstream-side neutralizing electrode 24 via the intermediate transfer belt 4 is provided. On the contrary, in an image forming apparatus where the upstream-side neutralizing electrode is provided, whereas the downstream-side neutralizing electrode 24 is not, only the leak current detector that detects a leak current flowing between the transfer member 13 and the upstream-side neutralizing electrode 26 via the intermediate transfer belt 4 is provided. Even when the transfer member 13, the downstream-side neutralizing electrode 24, and the upstream-side neutralizing electrode 26 are each formed of a roller, the leak current detector can be constituted like the above.

Since the transfer member 13, the downstream-side neutralizing electrode 24, and the upstream-side neutralizing electrode 26 are arranged close to one another, when a large amount of current flows from the transfer member 13 applied with a voltage with a plus polarity to the downstream-side neutralizing electrode 24 and the upstream-side neutralizing electrode 26 via the intermediate transfer belt 4, transfer of a toner image can be affected as described above.

It is preferable that a belt made of a material having an electric field dependency where a volume resistance of the belt placed outside an electric field is larger than that thereof placed in the electric field is used as the intermediate transfer belt 4. When an intermediate transfer belt made of such a material is placed in the electric field, the volume resistance of the intermediate transfer belt lowers according to increase in an electric field intensity. Therefore, when the intermediate transfer belt is in a non-electric field, the volume resistance thereof becomes maximized.

FIG. 12 is a schematic diagram for illustrating a relationship between the intermediate transfer belt 4 with the electric field dependency, the image carrier 3Y, the transfer member 13, the downstream-side neutralizing electrode 24, and the upstream-side neutralizing electrode 26. Since voltages are applied to the transfer member 13, the downstream-side neutralizing electrode 24, and the upstream-side neutralizing electrode 26 by the power sources 23, 25, 27, respectively, electric fields with high intensity are formed in portions Q1, Q2, Q3 of the intermediate transfer belt 4 positioned between the transfer member 13, the downstream-side neutralizing electrode 24, and the upstream-side neutralizing electrode 26, and the image carrier 3Y, so that volume resistances in the portions Q1, Q2, and Q3 are kept low. Therefore, voltages applied to the transfer member 13, the downstream-side neutralizing electrode 24, and the upstream-side neutralizing electrode 26 can be transmitted to the surface of the intermediate transfer belt 4 efficiently. Furthermore, since an electric field with high intensity is not formed in a portion P1 of the intermediate transfer belt 4 positioned between the portions Q1 and Q3 and in a portion P2 of the intermediate transfer belt 4 positioned between the portions Q1 and Q2, the volume resistances of the portions P1 and P2 are kept high. Therefore, large current can be blocked from flowing from the transfer member 13 to the downstream-side neutralizing electrode 24 and the upstream-side neutralizing electrode 26 via the portions P1 and P2. Thereby, since the transfer member 13, the downstream-side neutralizing electrode 24, and the upstream-side neutralizing electrode 26 contact with the intermediate transfer belt 4 at their proximal positions to one another, but it is possible to transfer a toner image on the image carrier 3Y to the intermediate transfer belt 4 without any trouble.

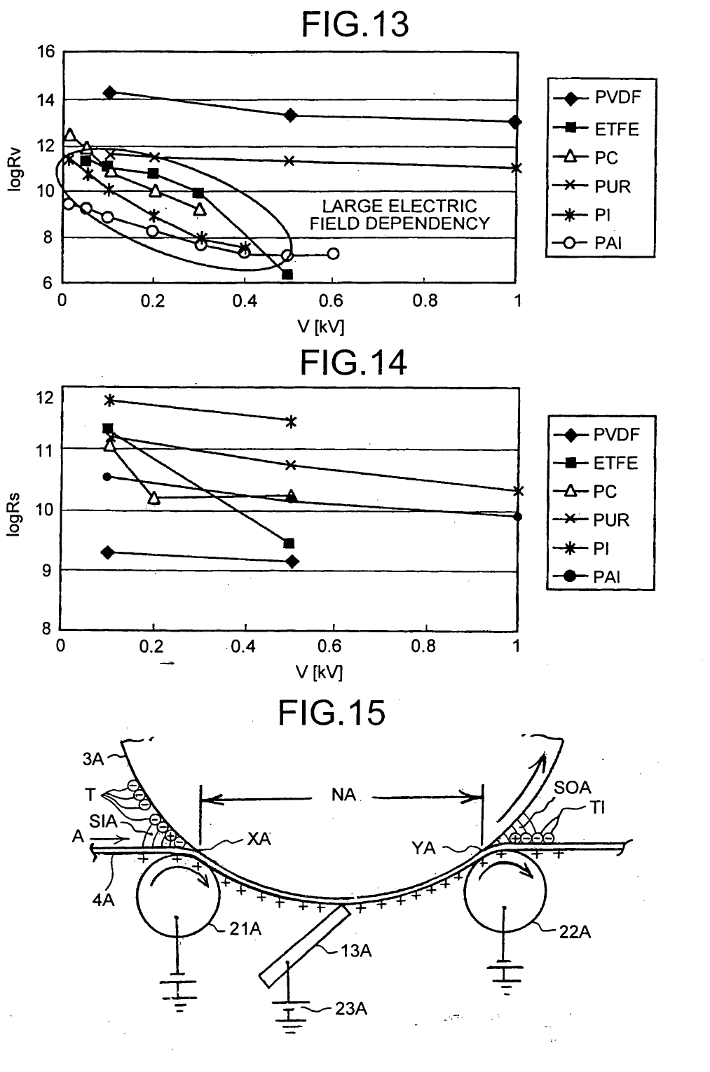

FIG. 13 is a graph for explaining an electric field dependency of a volume resistance of the intermediate transfer belt 4. When volume resistances of respective test pieces measured using a measuring method conforming with JISK 6911 (specifically, a resistance meter “HIRESTA-UP” (MCP-HT450) manufactured by Dia Instruments Co., Ltd. (formerly Mitsubishi Chemical Corporation)) are represented as Rᵥ (Ω·cm), FIG. 13 depicts that a vertical axis corresponds to log Rᵥ, while a transverse axis corresponds to application voltage V (kilovolt). A slope of the graph, namely, change amount of log Rᵥ/change amount of voltage value (kilovolt) represents magnitude of the electric field dependency of the volume resistance. Although the slope in a voltage value range of 0.1 kilovolt to 0.5 kilovolt is apparent in FIG. 13, it is preferable that the intermediate transfer belt 4 is made of a material with the change amount of log Rᵥ/change amount of voltage value (kilovolt) larger than 4 in the range. In FIG. 13, electric field dependencies of volume resistances of ethylene-tetrafluoroethylene (ETFE), polycarbonate (PC), polyimide (PI), and polyimide-amide (PAI) are large, so that it is preferable that the intermediate transfer belt is made of these materials.

The electric field dependency of the volume resistance becomes larger according to reduction of the thickness of the intermediate transfer belt 4. Therefore, it is preferable that the thickness of the intermediate transfer belt 4 is thin. However, when the thickness of the intermediate transfer belt 4 becomes thin, it becomes easily deformable, which results in deterioration of conveyance easiness and durability. Accordingly, it is desirable that the intermediate transfer belt is made of a material having a volume resistance with a high electric field dependency and the longitudinal elastic modulus of the intermediate transfer belt 4 is set to 3000 MPa or more. With the constitution, since the bending stiffness of the intermediate transfer belt 4 can be increased, even if the thickness of the intermediate transfer belt 4 is made thin, the conveyance easiness and the durability can be prevented from remarkably lowering. Specifically, by setting the longitudinal elastic modulus to 3000 MPa or more, it is possible to use an intermediate transfer belt made of polyimide and having a thickness of 60 micrometers or less.

On the other hand, when the electric field dependency of the surface resistance of the rear surface of the intermediate transfer belt 4 abutting on the transfer member 13 is high, current leakage through the rear surface of the intermediate transfer belt 4 becomes easy at a time of application of voltages to the transfer member 13, the downstream-side neutralizing electrode 24, and the upstream-side neutralizing electrode 26. Accordingly, it is advantageous that the electric field dependency of the surface resistance of the rear surface of the intermediate transfer belt 4 is lower.

FIG. 14 is a graph for explaining an electric field dependency of a surface resistance of the intermediate transfer belt 4. When surface resistances of respective test pieces measured using a measuring method conforming with JISK 6911 are represented as Rₛ (Ω/□), FIG. 14 depicts that a vertical axis corresponds to log Rₛ, while a transverse axis corresponds to application voltage V (kilovolt). A slope of the graph, namely, change amount of log RS/change amount of voltage value (kilovolt) represents magnitude of an electric field dependency of a surface resistance. Although the slope in a voltage value range of 0.1 kilovolt to 0.5 kilovolt is apparent in FIG. 14, it is preferable that the intermediate transfer belt 4 is made of a material with the change amount of log RS/change amount of voltage value (kilovolt) smaller than 1 in the range. When a surface resistance of the rear surface of the intermediate transfer belt 4, which is measured using a measuring method conforming with JISK 6911 and on which the transfer member 13 abuts, is represented as Rₛ (Ω/□), the intermediate transfer belt is made of a material with the change amount of log RS/change amount of voltage value (kilovolt) smaller than 1 in the voltage value range of 0.1 to 0.5 kilovolt. In FIG. 14, PI and PAI are preferable materials, and since these materials have high electric field dependencies of the volume resistance, an intermediate transfer belt made of PI or PAI can be adopted especially advantageously.

According to the present embodiment, the transfer member 13, the downstream-side neutralizing electrode 24, and the upstream-side neutralizing electrode 26 are caused to abut on the rear surface of the intermediate transfer belt 4. It is also possible to dispose these members so as to be separated from the rear surface of the intermediate transfer belt 4.

The constitutions for transferring toner images on the other image carriers 3C, 3M, 3BK to the intermediate transfer belt 4, and the constitutions for preventing generation of transfer dust at that time shown in FIG. 1 are the same as those shown in FIGS. 2 to 14.

While there has been explained an embodiment where the constitution according to the present invention is adopted in the image forming apparatus of the type in which toner images different in color from each other are formed on a plurality of image carriers and respective toner images are transferred on the intermediate transfer belt in the superimposing manner, the present invention can be applied to an image forming apparatus of a type in which toner images different in color are sequentially formed on one image carrier and the respective toner images are transferred on an intermediate transfer belt in a superimposing manner without any trouble.

According to the present invention, generation of transfer dust can be suppressed as compared with the conventional apparatus, and high quality images with can be formed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus that performs a primary transfer of a toner image formed on an image carrier to an intermediate transfer belt that is driven while contacting with the image carrier, and a secondary transfer of the toner image on the intermediate transfer belt to a recording medium to obtain a recorded image, the image forming apparatus comprising:
a transfer member that makes, when a range of a portion of the intermediate transfer belt contacting with the image carrier, which is positioned between the most upstream-side position and the most downstream-side position in a moving direction of the intermediate transfer belt, is defined as a contact region, a contact with a rear portion of the intermediate transfer belt within the contact region, as a primary transfer device that performs the primary transfer of the toner image on the image carrier to the intermediate transfer belt; and
a downstream-side neutralizing electrode that makes a contact with the rear portion of the intermediate transfer belt, which is positioned at a downstream-side in the moving direction of the intermediate transfer belt from a position where the transfer member makes a contact with the intermediate transfer belt and at an upstream-side in the moving direction of the intermediate transfer belt from the most downstream-side position, wherein
a transfer voltage with an opposite polarity to a regularly charged polarity of a toner is applied to the transfer member, and
a voltage with a same polarity as the regularly charged polarity of the toner is applied to the downstream-side neutralizing electrode.

2. The image forming apparatus according to claim 1, wherein
at least one of the transfer member and the downstream-side neutralizing member is formed with a blade.

3. The image forming apparatus according to claim 2, wherein
the blade is made of an elastic material with a volume resistance of 10⁶ Ω·cm to 10¹² Ω·cm.

4. The image forming apparatus according to claim 2, further comprising:
a supporting member that supports the blade, wherein
the supporting member is made of an elastic material.

5. The image forming apparatus according to claim 2, further comprising:
a supporting member that supports the blade; and
a conductive adhesive with adhesion covering a proximal end of the blade, wherein
the proximal end of the blade covered with the conductive adhesive is fitted into a groove formed in the supporting member,
the proximal end of the blade is brought in close contact with a surface dividing the groove via the conductive adhesive, and
a terminal of a power source that applies a voltage to the blade is adhered to the conductive adhesive.

6. The image forming apparatus according to claim 2, wherein
the blade is made of metal, and
the blade makes a contact with the intermediate transfer belt via a medium-resistance coating material coated on the blade.

7. The image forming apparatus according to claim 1, wherein
at least one of the transfer member and the downstream-side neutralizing member is formed with a roller.

8. The image forming apparatus according to claim 1, further comprising:
a leak-current detecting unit that detects a leak current flowing between the transfer member and the downstream-side neutralizing electrode via the intermediate transfer belt.

9. The image forming apparatus according to claim 1, wherein
the intermediate transfer belt is made of a material having an electric field dependency showing a volume resistance obtained when the intermediate transfer belt is placed outside an electric field is larger that that obtained when the intermediate transfer belt is placed inside the electric field.

10. The image forming apparatus according to claim 9, wherein,
a change amount of log Rᵥ/a change amount of a voltage in kilovolt of the material is larger than 4 when the voltage is in a range of 0.1 kilovolt to 0.5 kilovolt, where Rᵥ in Ω·cm is the volume resistance of the intermediate transfer belt measured by a measuring method conforming to JISK 6911.

11. The image forming apparatus according to claim 10, wherein
a longitudinal elastic modulus of the intermediate transfer belt is equal to or larger than 3000 MegaPascals.

12. The image forming apparatus according to claim 1, wherein
the intermediate transfer belt is made of a material having a change amount of log Rₛ/a change amount of a voltage in kilovolt larger than 4 when the voltage is in a range of 0.1 kilovolt to 0.5 kilovolt, where Rₛ in Ω/□ is a surface resistance of the intermediate transfer belt positioned on a side on which the transfer member abuts measured by a measuring method conforming to JISK 6911.

13. An image forming apparatus that performs a primary transfer of a toner image formed on an image carrier to an intermediate transfer belt that is driven while contacting with the image carrier, and a secondary transfer of the toner image on the intermediate transfer belt to a recording medium to obtain a recorded image, the image forming apparatus comprising:
a transfer member that makes, when a range of a portion of the intermediate transfer belt contacting with the image carrier, which is positioned between the most upstream-side position and the most downstream-side position in a moving direction of the intermediate transfer belt, is defined as a contact region, a contact with a rear portion of the intermediate transfer belt within the contact region, as a primary transfer device that performs the primary transfer of the toner image on the image carrier to the intermediate transfer belt; and
an upstream-side neutralizing electrode that makes a contact with the rear portion of the intermediate transfer belt, which is positioned at an upstream-side in the moving direction of the intermediate transfer belt from a position where the transfer member makes a contact with the intermediate transfer belt and at a downstream-side in the moving direction of the intermediate transfer belt from the most upstream-side position, wherein
a transfer voltage with an opposite polarity to a regularly charged polarity of a toner is applied to the transfer member, and
a voltage with a same polarity as the regularly charged polarity of the toner is applied to the upstream-side neutralizing electrode.

14. The image forming apparatus according to claim 13, wherein
at least one of the transfer member and the upstream-side neutralizing member is formed with a blade.

15. The image forming apparatus according to claim 14, wherein
the blade is made of an elastic material with a volume resistance of 10⁶ Ω·cm to 10¹² Ω·cm.

16. The image forming apparatus according to claim 14, further comprising:
a supporting member that supports the blade, wherein
the supporting member is made of an elastic material.

17. The image forming apparatus according to claim 14, further comprising:
a supporting member that supports the blade; and
a conductive adhesive with adhesion covering a proximal end of the blade, wherein
the proximal end of the blade covered with the conductive adhesive is fitted into a groove formed in the supporting member,
the proximal end of the blade is brought in close contact with a surface dividing the groove via the conductive adhesive, and
a terminal of a power source that applies a voltage to the blade is adhered to the conductive adhesive.

18. The image forming apparatus according to claim 14, wherein
the blade is made of metal, and
the blade makes a contact with the intermediate transfer belt via a medium-resistance coating material coated on the blade.

19. The image forming apparatus according to claim 13, wherein
at least one of the transfer member and the upstream-side neutralizing member is formed with a roller.

20. The image forming apparatus according to claim 13, further comprising:
a leak-current detecting unit that detects a leak current flowing between the transfer member and the upstream-side neutralizing electrode via the intermediate transfer belt.

21. The image forming apparatus according to claim 13, wherein
the intermediate transfer belt is made of a material having an electric field dependency showing a volume resistance obtained when the intermediate transfer belt is placed outside an electric field is larger that that obtained when the intermediate transfer belt is placed inside the electric field.

22. The image forming apparatus according to claim 21, wherein,
a change amount of log Rᵥ/a change amount of a voltage in kilovolt of the material is larger than 4 when the voltage is in a range of 0.1 kilovolt to 0.5 kilovolt, where Rᵥ in Ω·cm is the volume resistance of the intermediate transfer belt measured by a measuring method conforming to JISK 6911.

23. The image forming apparatus according to claim 22, wherein
a longitudinal elastic modulus of the intermediate transfer belt is equal to or larger than 3000 MegaPascals.

24. The image forming apparatus according to claim 13, wherein
the intermediate transfer belt is made of a material having a change amount of log Rₛ /a change amount of a voltage in kilovolt larger than 4 when the voltage is in a range of 0.1 kilovolt to 0.5 kilovolt, where Rₛ in Ω/□ is a surface resistance of the intermediate transfer belt positioned on a side on which the transfer member abuts measured by a measuring method conforming to JISK 6911.

25. An image forming apparatus that performs a primary transfer of a toner image formed on an image carrier to an intermediate transfer belt that is driven while contacting with the image carrier, and a secondary transfer of the toner image on the intermediate transfer belt to a recording medium to obtain a recorded image, the image forming apparatus comprising:
a transfer member that makes, when a range of a portion of the intermediate transfer belt contacting with the image carrier, which is positioned between the most upstream-side position and the most downstream-side position in a moving direction of the intermediate transfer belt, is defined as a contact region, a contact with a rear portion of the intermediate transfer belt within the contact region, as a primary transfer device that performs the primary transfer of the toner image on the image carrier to the intermediate transfer belt;
a downstream-side neutralizing electrode that makes a contact with the rear portion of the intermediate transfer belt, which is positioned at a downstream-side in the moving direction of the intermediate transfer belt from a position where the transfer member makes a contact with the intermediate transfer belt and at an upstream-side in the moving direction of the intermediate transfer belt from the most downstream-side position; and
an upstream-side neutralizing electrode that makes a contact with the rear portion of the intermediate transfer belt, which is positioned at an upstream-side in the moving direction of the intermediate transfer belt from a position where the transfer member makes a contact with the intermediate transfer belt and at a downstream-side in the moving direction of the intermediate transfer belt from the most upstream-side position, wherein
a transfer voltage with an opposite polarity to a regularly charged polarity of a toner is applied to the transfer member, and
a voltage with a same polarity as the regularly charged polarity of the toner is applied to the downstream-side neutralizing electrode and the upstream-side neutralizing electrode.

26. The image forming apparatus according to claim 25, wherein
at least one of the transfer member, the downstream-side neutralizing member, and the upstream-side neutralizing electrode is formed with a blade.

27. The image forming apparatus according to claim 26, wherein
the blade is made of an elastic material with a volume resistance of 10⁶ Ω·cm to 10¹² Ω·cm.

28. The image forming apparatus according to claim 26, further comprising:
a supporting member that supports the blade, wherein
the supporting member is made of an elastic material.

29. The image forming apparatus according to claim 26, further comprising:
a supporting member that supports the blade; and
a conductive adhesive with adhesion covering a proximal end of the blade, wherein
the proximal end of the blade covered with the conductive adhesive is fitted into a groove formed in the supporting member,
the proximal end of the blade is brought in close contact with a surface dividing the groove via the conductive adhesive, and
a terminal of a power source that applies a voltage to the blade is adhered to the conductive adhesive.

30. The image forming apparatus according to claim 26, wherein
the blade is made of metal, and
the blade makes a contact with the intermediate transfer belt via a medium-resistance coating material coated on the blade.

31. The image forming apparatus according to claim 26, wherein
the blade constituting the upstream-side neutralizing electrode and the blade constituting the downstream-side neutralizing electrode are formed integrally.

32. The image forming apparatus according to claim 25, wherein
at least one of the transfer member, the downstream-side neutralizing member, and the upstream-side neutralizing electrode is formed with a roller.

33. The image forming apparatus according to claim 25, further comprising:
a first leak-current detecting unit that detects a leak current flowing between the transfer member and the downstream-side neutralizing electrode via the intermediate transfer belt; and
a second leak-current detecting unit that detects a leak current flowing between the transfer member and the upstream-side neutralizing electrode via the intermediate transfer belt.

34. The image forming apparatus according to claim 25, wherein
the intermediate transfer belt is made of a material having an electric field dependency showing a volume resistance obtained when the intermediate transfer belt is placed outside an electric field is larger that that obtained when the intermediate transfer belt is placed inside the electric field.

35. The image forming apparatus according to claim 34, wherein,
a change amount of log Rᵥ/a change amount of a voltage in kilovolt of the material is larger than 4 when the voltage is in a range of 0.1 kilovolt to 0.5 kilovolt, where Rᵥ in Ω·cm is the volume resistance of the intermediate transfer belt measured by a measuring method conforming to JISK 6911.

36. The image forming apparatus according to claim 35, wherein
a longitudinal elastic modulus of the intermediate transfer belt is equal to or larger than 3000 MegaPascals.

37. The image forming apparatus according to claim 25, wherein
the intermediate transfer belt is made of a material having a change amount of log Rₛ /a change amount of a voltage in kilovolt larger than 4 when the voltage is in a range of 0.1 kilovolt to 0.5 kilovolt, where Rₛ in Ω/□ is a surface resistance of the intermediate transfer belt positioned on a side on which the transfer member abuts measured by a measuring method conforming to JISK 6911.
